(19) United States
(12) Patent Application Publication
(10) Pub. No.: US 2014/0267875 A1
(43) Pub. Date: Sep. 18, 2014

(54) IMAGING METHOD AND SYSTEM WITH OPTICAL PATTERN GENERATOR

(71) Applicant: QUALCOMM MEMS TECHNOLOGIES, INC., San Diego, CA (US)

(72) Inventors: Russell W. Gruhlke, Milpitas, CA (US); Ying Zhou, San Jose, CA (US); John M. Wyrwas, Berkeley, CA (US); Xiquan Cui, San Jose, CA (US); Thomas Brown, Rochester, NY (US); Todor Georgiev, Sunnyvale, CA (US)

(73) Assignee: QUALCOMM MEMS TECHNOLOGIES, INC., San Diego, CA (US)

(21) Appl. No.: 13/841,104

(22) Filed: Mar. 15, 2013

(51) Int. Cl. H04N 5/238

(52) U.S. Cl. CPC H04N 5/238
USPC 348/335

(57) ABSTRACT

This disclosure provides systems, methods and apparatus for imaging. In one aspect, the imaging system can include a light sensor, a light guide, an optical pattern generator, and a processor. The light guide can include light turning features configured to receive ambient light and to direct the ambient light out through an output surface of the light guide to the light sensor. The optical pattern generator can be configured to generate a light intensity pattern upon the passage of the ambient light through the optical pattern generator and project the light intensity pattern onto the light sensor. The processor can be configured to construct an image based on the light intensity pattern.

### TECHNICAL FIELD

This disclosure relates to imaging systems, such as lenless image capture systems, including lenless image capture systems integrated with electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Many devices include displays (such as IMOD-based displays) and also imaging systems, such as cameras. Often, the camera includes a relatively small aperture with a lens that focuses ambient light from a scene to be captured onto a relatively small area of a sensor. By focusing the incident light from the scene onto the sensor, a real spatial image of the scene can be formed on the sensor. To meet market demands and design criteria for devices incorporating imaging systems, new imaging systems are continually being developed.

### SUMMARY

The systems, methods and devices of this disclosure each have several innovative aspects, no single one of which is solely responsible for the desirable attributes disclosed herein.

One innovative aspect of the subject matter described in this disclosure can be implemented in an imaging system. The imaging system can include a light sensor, a light guide, an optical pattern generator, and a processor. The light guide can include a plurality of light turning features. At least some of the light turning features can be configured to receive ambient light and to direct the ambient light out through an output surface of the light guide to the light sensor. The optical pattern generator can be disposed between the output surface of the light guide and the light sensor. The optical pattern generator can be configured to generate a light intensity pattern upon the passage of the ambient light through the optical pattern generator, and to project the light intensity pattern onto the light sensor. The processor can be in communication with the light sensor and can be configured to construct an image based on the light intensity pattern.

In some implementations, the ambient light incident on different portions of a major surface of the light guide can cause different light intensity patterns. The processor can be configured to access a database that includes reference characterizations of light intensity patterns. Each reference characterization can be associated with light incident on a different portion of the major surface. The processor can also be configured to determine which portions of the major surface received ambient light based upon the light intensity patterns and the reference characterizations.

In some implementations, the light turning features are configured to receive the ambient light from substantially the same range of angular directions. Furthermore, each light turning feature can be configured to turn the ambient light received from a range of angular directions. The ranges for at least some of the light turning features can at least partially overlap. At least some of the light turning features can be configured to turn the ambient light received from a cone having an acceptance angle range of about 60 degrees to about 90 degrees, relative to a central axis of the cone. In some implementations, the light turning features include light turning facets. For example, each of the light turning facets can include sides of a truncated cone.

In some implementations of the imaging system, the light sensor is disposed facing an edge of the light guide. One or more additional light sensors can be disposed facing one or more other edges of the light guide. The optical pattern generator can be configured to project the light intensity pattern onto the one or more additional light sensors. The optical pattern generator can include an array of apertures or an array of lenses. The array of lenses can include an array of curved surfaces facing the light sensor or an array of curved surfaces facing the light-output surface of the light guide.

In some implementations, the imaging system further includes a display device underlying the light guide. For example, the display device can be a reflective display. The reflective display can include a plurality of interferometric modulator display elements. In some implementations, the processor can be configured to communicate with the display and can be configured to process image data.

Another innovative aspect of the subject matter described in the disclosure can be implemented in an imaging system. The imaging system can include a light sensor, a light guide, an optical pattern generating means, and means for processing. The light guide can include a plurality of light turning means. At least some of the light turning means can be configured to receive ambient light and to direct the ambient light out through an output surface of the light guide to the light sensor. The optical pattern generating means can be disposed between the output surface of the light guide and the light sensor. The optical pattern generating means can be configured to generate a light intensity pattern upon the passage of the ambient light through the optical pattern generating means, and to project the light intensity pattern onto the light sensor. The means for processing can be in communication with the light sensor. The processing means can be configured to construct an image based on the light intensity pattern.

In some implementations, the light turning means can include light turning facets. The optical pattern generating means can include at least one of an array of apertures and an array of lenses. For example, the array of apertures can include an opaque edge mask with apertures. As another example, the array of lenses can include at least one of an array of curved surfaces facing the light sensor and an array of curved surfaces facing the light-output surface of the light guide. In certain implementations, the processing means can include a processor.

In various implementations, ambient light incident on different portions of a major surface of the light guide can cause different light intensity patterns. The processing means can be configured to access a database that includes reference characterizations of light intensity patterns. Each reference characterization can be associated with light incident on a different portion of the major surface. The processing means can also determine which portions of the major surface received ambient light based upon the light intensity patterns and the reference characterizations. The light turning means can be configured to receive the ambient light from substantially the same range of angular directions.

Another innovative aspect of the subject matter described in this disclosure can be implemented in a non-transitory tangible computer storage medium. The computer storage medium can have instructions stored to direct a processor to construct an image. The instructions can direct the processor to construct an image by receiving signals indicative of a light intensity pattern from a light sensor. The light intensity pattern can correspond to light distributions caused by the ambient light incident on different portions of a major surface of a light guide. The instructions can also direct the processor to construct the image by accessing a database that includes reference characterizations of different light intensity patterns. Each reference characterization can be associated with light incident on a different portion of the major surface. The instructions can also include determining which portions of the major surface received ambient light based upon the light intensity pattern and the reference characterizations; and constructing the image based on the determined portions. In some implementations, determining which portions of the major surface received ambient light can include using a pseudo-inverse matrix relating to the reference characterizations.

Details of one or more implementations of the subject matter described in this disclosure are set forth in the accompanying drawings and the description below. Although some of the examples provided in this disclosure are described in terms of EMS and MEMS-based displays the concepts provided herein may apply to non-display devices and to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A is a perspective view of an example of an imaging system configured to construct an image.

FIG. 1B is a side view of a light guide, illustrating a light turning feature redirecting incident light towards a light sensor.

FIG. 1C illustrates an example of an angular direction and cone of acceptance angles for which a light turning feature may be configured to turn ambient light.

FIGS. 2A and 2B illustrate top-down views of examples of an optical pattern generator generating a light intensity pattern when light striking a light guide at different locations pass through the optical pattern generator.

FIGS. 3A and 3B illustrate top-down views of examples of an optical pattern generator generating a light intensity pattern when light strikes a light guide at different distances from the optical pattern generator.

FIG. 4 illustrates a top-down view of an example of a light guide and optical pattern generator providing zones with different resolutions in conjunction with a light sensor having a length less than the light output surface of the light guide on which the light sensor is disposed.

FIGS. 5 and 6 illustrate top-down views of examples of an optical pattern generator formed of an array of lenses disposed between the light output surface of a light guide and a light sensor.

FIG. 7 illustrates a perspective view of an example of an imaging system including multiple light sensors disposed facing multiple light output surfaces of the light guide.

FIG. 8 illustrates a top-down view of an example of an imaging system with a major surface divided into multiple portions p₁, p₂, p₃, and p₄ and a light sensor divided into multiple portions s₁, s₂, s₃, . . . s₃₂.

FIGS. 9A-9D illustrate examples of reference characterizations associated with light incident on the different portions p₁, p₂, p₃, and p₄ of the major surface shown in FIG. 8.

FIG. 10 illustrates a top-down schematic view of an experimental imaging system.

FIG. 11 illustrates a visual representation of examples of the reference characterizations determined for the experimental imaging system shown in FIG. 10.

FIGS. 12A-12B illustrate original scenes captured by the experimental imaging system shown in FIGS. 10 and 11.

12C-12D illustrate images constructed with the experimental imaging system shown in FIGS. 10 and 11.

FIG. 13A illustrates an example method of constructing an image.

FIG. 13B illustrates an example of instructions implemented on a computer-readable medium used to direct a processor to construct an image.

FIG. 14 is an isometric view illustration depicting two adjacent interferometric modulator (IMOD) display elements in a series or array of display elements of an IMOD display device.

FIG. 15 is a system block diagram illustrating an electronic device incorporating an IMOD-based display including a three element by three element array of IMOD display elements.

FIGS. 16A and 16B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Cameras are used in many applications to capture images of a scene by using one or more lenses that focus light onto a sensor. The lens(es) may be configured to accept ambient light that is incident upon the lens(es) from a range of angles and to focus the light on the sensor to form a real spatial image on the sensor. Cameras can be difficult to integrate into devices where a small or thin form factor is desired, since the cameras can be relatively deep and bulky structures, due to, for example, the need to accommodate optical elements and to provide a length for light to properly focus on a sensor. Simply reducing the sizes of the cameras, however, can reduce the apertures of the cameras, which can decrease light collection efficiency and degrade image quality.

In some implementations, rather than a lens, a light guide may be used to collect light and direct the light to a light sensor. The light guide can provide a relatively large surface area for receiving light and, in some implementations, a substantially flat surface that can be integrated into devices to provide other functionality. In addition, certain implementations described herein include an imaging method and system, which can allow an image of a scene to be captured without directing light to form the image on the light sensor. Rather, light received at different locations on the light guide's surface is made to form different patterns on the light sensor. The different patterns may be substantially unique for each location on the light guide surface. Detection of different patterns by the light sensor allows an image to be constructed by correlating those patterns with the particular locations on the light guide surface which have received light. Thus, the locations on the light guide surface receiving light can be mapped and an image constructed based on this mapping.

For example, in some implementations, an imaging system can include a light sensor, a light guide, an optical pattern generator, and a processor. The light guide can include light turning features configured to receive and direct ambient light out through an output surface of the light guide to overlapping portions of the light sensor. The optical pattern generator can generate a light intensity pattern upon the passage of the ambient light through the optical pattern generator. The optical pattern generator can also project the light intensity pattern onto the light sensor. The processor, in communication with the light sensor, can construct an image based on the light intensity pattern. Some implementations can include light turning features that can receive light from substantially all and any angular directions, for example, receive light without angle discrimination.

Particular implementations of the subject matter described in this disclosure can be implemented to realize one or more of the following potential advantages. Various implementations enable the design of thin imaging systems, exceptionally thin imaging systems in some cases. For example, various implementations can construct an image without needing to the use of lens(es) to form a real spatial image on a light sensor, and thus without needing to consider or accommodate the focal length(s) of the lens(es). This may reduce the costs and bulk of devices by eliminating the lens(es), their associated costs, and their associated need for adequate focal lengths. In some implementations, the number of components of an electrical device, such as a smartphone or mobile computing device, may be reduced where surfaces can be used for more than one purpose, for example, for both displaying and capturing images. In some implementations, a display for a computer, cell phone, smartphone, personal digital assistant, or other electronic device, including mobile devices, may be able to both display images to a viewer while also collecting ambient light for imaging objects that are in front of the display. In this way, the display may serve both the purpose of displaying and capturing images. Because the area of the display can be used to collect light, the amount of light flux collected for imaging can increase relative to the amount collected for a conventional camera typically used with displays, thereby increasing the sensitivity of the imaging system and, ultimately, the image quality. In some implementations, for example, in a two-way video communication system, two or more video conference participants may watch live video images of each other. The display screen used by a participant may itself include an imaging system to take a live, moving image of the participant to send for the other participants to view. In some implementations, the light guide may be any transparent structure, for example, an architectural structure such as part of a wall or window, thereby allowing integration of the imaging system in many common structures. In addition, manufacturing yields may be increased and costs decreased, since the use of patterns to construct images can increase the margins of error for various components of the imaging system. For instance, the relevant reference characterizations of patterns for correlating light received by the light guide may be calibrated for each system, thereby allowing a high level of tolerance for variations between individual systems.

FIG. 1A is a perspective view of an example of an imaging system configured to construct an image. The imaging system 100 can include a light sensor 110, a light guide 120, an optical pattern generator 140, and a processor 150. The light guide 120 can include light turning features 130. At least some of the light turning features 130 can be configured to receive ambient light and to direct the ambient light out through an output surface 123 of the light guide 120 to portions of the light sensor 110. In some implementations, at least some of the light turning features 130, which may receive ambient light from different directions, can direct the ambient light to overlapping portions of the light sensor 110, such that light from different light turning features 130 (and, potentially, received from different directions) can be superimposed on the same portions of the light sensor 110. For example, in some implementations, two or more light turning features 130 from different portions of the light guide 120 can receive and direct light to the same portion of the light sensor 110. In some implementations, this may be the case even if the light is received from different directions (for example, directions differing from one another by angles of 5 degrees or more, 10 degrees or more, 20 degrees or more, 30 degrees or more, or 45 degrees or more). Additionally, in some implementations, one light turning feature 130 may direct light to several portions of the light sensor 110. An optical pattern generator 140 can be disposed between the output surface 123 of the light guide 120 and the light sensor 110. The optical pattern generator 140 can be configured to generate a light intensity pattern upon the passage of the ambient light through the optical pattern generator 140. The optical pattern generator 140 further can be configured to project the light intensity pattern onto the light sensor 110. The processor 150 can be in communication with the light sensor 110. The processor 150 can be configured to construct an image based on the light intensity pattern projected onto the light sensor 110 resulting from the passing of the light turned by the light turning features 130 through the optical pattern generator 140. The processor 150 can include one or more computer processors or computer systems configured to take light intensity pattern information provided by the image sensor to construct the image.

In general, in various implementations, to capture an image of a scene, light from the scene impinges on the light guide 120, which has light receiving portions p₁, p₂, p₃, . . . pₘ having light turning features 130 that direct the light through the light guide 120, through the optical pattern generator 140, and to overlapping portions s₁, s₂, s₃, . . . sₙ of the light sensor 110 facing the light output edge 123 of the light guide 120. Ambient light incident on different portions p₁, p₂, p₃, . . . pₘ of a light receiving surface of the light guide 120 can cause different light intensity patterns. In some implementations where two or more light turning features 130 from different portions (for example, p₁ and p₂) of the light guide 120 receive and direct light to the same portion (for example, s₂) of the light sensor 110, the light intensity pattern received at the portion (for example, s₂) of the light sensor 110 can be a superposition (or the superimposed light intensity pattern) of each individual light intensity pattern for each of the different portions (for example, p₁ and p₂) of the light guide 120. Because each light receiving portion p₁, p₂, p₃, . . . or pₘ (which may be considered a virtual pixel, photosite, or sense/) produces an unique reference characterization of a light intensity pattern, it is possible to determine which of the light receiving portions p₁, p₂, p₃, . . . or pₘ have received light based on the light intensity pattern produced by the received light. Using this information, an image of the scene can be constructed, for example, by effectively “filling in” a grid (implemented in software) at locations corresponding to the light receiving portions p₁, p₂, p₃, . . . or pₘ that were found, by correlating the observed light intensity patterns with the reference characterizations, to have received light.

In certain implementations, the light guide 120 can be substantially planar and transparent. In some implementations, the light guide 190 can be formed of one or more layers of optically transmissive material. Examples of materials can include the following: acrylics, acrylate copolymers, UV-curable resins, polycarbonates, cycloolefin polymers, polymers, organic materials, inorganic materials, silicates, alumina, sapphire, polyethylene terephthalate (PET), polyethylene terephthalate glycol (PET-G), silicon oxynitride, and/or combinations thereof.

In some implementations, the light guide 120 can be a slab of glass or plastic that can overlay a display. Examples of suitable display types can include IMOD-based displays or liquid crystal-based displays. As shown in FIG. 1A, the light guide 120 can include a front surface 121 configured to receive light, for example light reflecting off of an object to be imaged. The object can be a 3-D object (such as a face of a person) or a 2-D object (such as a document to be scanned). As used herein, the front surface 121 can refer to a surface of the light guide 120 facing an object or scene sought to be imaged. Light to illuminate the object can come from the ambient environment or may be provided by the imaging system. In either case, the light received by the light guide 120 may be considered ambient light, since the light is received by the light guide 120 from outside the light guide 120. For example, ambient light may be scattered from the face of a person in front of the light guide 120, or from an object (for example, a page) disposed on the front surface 121. The scattered light may be light from a light source separate from the imaging system, or light from a light source that provided as part of the imaging system.

The light guide 120 also can include a back surface 122. The back surface 122 can refer to a surface of the light guide 120 opposite the front surface 121. Additionally, the light guide 120 can include edges 123, 124, 125, and 126. While the light output surface 123 is illustrated as one of the edges of the light guide 120, in various implementations, it is possible for the light output surface to be one or more of the front surface 121, the back surface 122, and the edges of the light guide 120 disposed about the front 121 and back 122 surfaces (e.g., edges 123, 124, 125, and 126).

The front surface 121, the back surface 122, and the edges 123-126 can be rectangular in shape as shown in FIG. 1A. However, other shapes, e.g., circular, ovular, or square, are also contemplated. In certain implementations, at least one of the front 121 and back 122 surfaces can be a major surface. For example, both the front 121 and back 122 surfaces can be major surfaces of the light guide 120, while the edges 123-126 can be smaller minor surfaces. In other implementations, the front 121 and back 122 surfaces can be minor surfaces, while the edges 123-126 can be major surfaces.

In certain implementations, ambient light can be incident on different portions of a major surface, for example, the front 121 surface of the light guide 120. As shown in FIG. 1A, ambient light can be incident on different portions p₁, p₂, p₃, pₘ of the front surface 121 of the light guide 120. Although the portions p₁, p₂, p₃, pₘ are illustrated as disposed only on the front surface 121, the portions p₁, p₂, p₃, . . . pₘ can extend over any part of the front surface 121, back surface 122, and edges 123-126. Thus, in other implementations, ambient light can be incident on different portions of a minor surface, e.g., 123, 124, 125, or 126, or on one or more of a major and minor surface 121-126 of the light guide 120.

The light guide 120 can include light turning features 130. Some of the light turning features 130 can be configured to receive the ambient light and to direct at least a portion of the light out through an output surface 123 of the light guide 120 to overlapping portions of the light sensor 110. FIG. 1B is a side view of the light guide 120, illustrating a light turning feature 130 redirecting incident light towards the light sensor 110. As shown in FIG. 1B, the light-turning features 130 can turn or redirect incident light so as to trap the light within the light guide 120. Some of the light can then propagate via total internal reflection to the peripheral light sensor 110 for detection.

Some of the light turning features 130 can be formed onto one or more of the major and minor surfaces. As shown in FIG. 1A, the light turning features 130 can be formed on the back surface 122 of the light guide 120. The light turning features 130, in some implementations, can form light receiving pixels correlating to the portions p₁, p₂, p₃, . . . pₘ of the light receiving surface of the light guide 120. The light turning features 130 can include light turning facets, for example, sides of a truncated cone or frustum. In other implementations, the light turning features 130 can include other light turning structures, e.g., refractive or reflective micro-optical structures, diffractive elements (for example, diffraction gratings), or holograms (for example, a holographic turning film). In some implementations, the light turning features 130 can be formed on both the front surface 121 and the back surface 122. In some other implementations, the light turning features 130 can be formed on one or more of the front surface 121, the back surface 122, and the edges 123-126. In some implementations, the light turning features 130 are formed on the back surface 122.

The light turning features 130 can be configured to turn ambient light received within particular ranges of angular direction(s). In some implementations, the light turning features 130 can be configured to turn ambient light received from the same or different angular direction and/or ranges of angular directions, with the range of angular directions for a particular light turning feature 130 also referred to as the angular directions encompassed within the cone of acceptance angles for that light turning feature 130. FIG. 1C illustrates an example of an angular direction and cone of acceptance angles for which a light turning feature 130 may be configured to turn ambient light. In some implementations, a light turning feature 130 may be configured to turn light that strikes the light turning feature in a direction normal to the front surface 121 of the light guide 120 (FIG. 1A), or within a range of directions encompassed by a cone that is centered about the normal. In some other implementations, the central axis about which the cone of acceptance angles is formed can be tilted with respect to the normal. As shown in FIG. 1C, the angular direction can be tilted by θ_{incid} from the normal to the surface receiving the incident light. Thus, the central axis of the cones of acceptance angles can be tilted from a direction normal to the surface receiving the light. The sides of the cones of acceptance angles can be defined by angle θ_{acc} in all directions from the central axis of the cone. The range of angular directions turned by a light turning feature 130, thus, can include all angular directions incident within the cone of acceptance angles.

In some implementations, different light turning features can have cones of acceptance angles having central axes extending in different angular directions and/or different sized cones of acceptance angles. In some implementations, at least some of the light turning features 130 can have cones of acceptance angles that are centered in the same direction. Also, in some implementations, at least some of the cones can have ranges of acceptance angles that at least partially overlap. For example, for two light turning features each having a cone of acceptance angles with a central axis parallel to a direction normal to the surface receiving the light, one light turning feature may turn ambient light received within a cone having a θ_{acc} of about 60 degrees to about 90 degrees, while the other light turning feature may turn ambient light received within a cone having a θ_{acc} of about 70 degrees to about 90 degrees.

In some other implementations, each of the light turning features 130 in the light guide 120 can be configured to turn ambient light received from substantially the same range of angular directions. In some implementations, each of the light turning features 130 can be configured to isotropically turn ambient light. The term “isotropic,” as used herein, can refer to the property of turning light received from a wide range of directions, for example, up to and including cones of acceptance angles that include θ_{acc}'s of about 25 degrees, 45 degrees, 65 degrees, or 90 degrees. Thus, in certain implementations, the light turning features 130 do not necessarily receive light in an angle discriminatory manner, but can receive and turn light from substantially all or any angular direction. For example, in some implementations, all light striking the light guide 120 (and not reflected off the light guide 120) can have an equal probability of being turned by a light turning feature 130. In some implementations, the ranges of acceptance angles may be narrow, which can improve resolution. For example, the cone of acceptance angles can have a θ_{acc} of, e.g., below about 10 degrees, below about 7 degrees, below about 5 degrees, below about 3 degrees, or below about 2 degrees.

With reference again to FIG. 1A, due to scattering and divergent in-plane propagation of light through the light guide 120, the signal intensity provided by light that will ultimately strike the sensor 110 may proportionally attenuate to the square of the propagation distance. Thus, the signal change corresponding to a small change of the light distribution associated with light received at different locations on the front surface 121 can be subtle and difficult to resolve. As a result, to improve the ability to reconstruct the image, in certain implementations, before reaching the light sensor 110, the directed light can pass through an optical pattern generator 140. The optical pattern generator 140 can be disposed between the output surface 123 of the light guide 120 and the light sensor 110. The optical pattern generator 140 can be configured to generate a light intensity pattern upon the passage of the ambient light through it. The optical pattern generator 140 further can project the light intensity pattern onto the light sensor 110.

In certain implementations, the optical pattern generator 140 can create a projection of the light profile with modulation onto the light sensor 110, from which the light sensor 110 can resolve finer details of the light distribution from not only the intensity but also the phase information in the light passing through the optical pattern generator 140. An optical pattern generator 140 as used herein can refer to a device that is configured to modulate a light profile (for example, a light intensity distribution) to form a light intensity pattern. For example, the light intensity pattern can be a pattern with discrete bands of light, which allows quantization of the light intensity distribution (for example, constraining gradual, continuous changes in the light intensity distribution into a smaller set of discrete values, the differences between which are more easily detected). For example, an optical pattern generator 140 can refer to an optical component that can discriminate intensity, spatial, and/or angular information of light and facilitate quantization of this information, which may otherwise change so gradually between light received at different points on the front surface 121 that detection of the change is difficult. Therefore, in certain implementations, an optical pattern generator 140 can project a light intensity pattern derived by modulating light, from the light output surface 123 of the light guide 120, so that the light sensor 110 can detect a signal with increased discrimination compared to a relatively broad signal without modulation. For example, an optical pattern generator 140 can change a relatively broad signal to multiple peaks with variable spacing. The intensity and spacing of the discrete peaks can be easier to discriminate and measure. In some implementations, the optical pattern generator 140 can include an array of apertures or an array of lenses. The light profile can be modulated with a frequency determined by the spacing of the array of apertures or by the spacing of the array of lenses through which light outputted from the light guide 120 travels to the light sensor 110.

FIGS. 2A and 2B illustrate top-down views of examples of an optical pattern generator 140 generating a light intensity pattern when light striking the light guide 120 at different locations pass through the optical pattern generator 140. As shown in FIG. 2A, light can strike the light guide 120 in the upper right hand corner, for example, at a location 131. The light guide 120 has light turning features 130 (such as light turning facets) that can turn and redirect the incident light so that it propagates within the light guide 120 and towards the optical pattern generator 140. In some implementations, the light turning features 130 can be configured to turn the light such that it propagates in substantially all directions. For example, in such implementations, three additional optical pattern generators 140 and three additional light sensors 110 can be disposed on the other three sides. Light from location 131 can be reflected to the three other sides of the light guide 120 and pass through the other three optical pattern generators 140 and onto the other three light sensors 110. The optical pattern generator 140 shown in FIGS. 2A and 2B can be a photo mask or an edge mask disposed between the light output surface of the light guide 120 and the light sensor 110. In some implementations, the optical pattern generator 140 can be disposed in contact with the light guide 120 or spaced apart from the light guide 120 and light sensor 110. The array of apertures of the edge mask can transmit the light towards the sensor 110 to generate a signal 200 including a series of peaks spaced apart from each other. As shown in FIG. 2B, if light strikes the light guide 120 in the lower right hand corner (for example, at a location 132) of the light guide 120, the pattern of the signal 200 detected also shifts to the lower light sensing surface of the light sensor 110. These peaks and the spaces between them can provide a higher signal-to-noise ratio than simply having the light strike the light sensor 110 without passing through the optical pattern generator 140.

FIGS. 3A and 3B illustrate top-down views of examples of an optical pattern generator generating a light intensity pattern when light strikes a light guide at different distances from the optical pattern generator. FIG. 3A is similar to the example shown in FIG. 2A with light striking the light guide 120 at a location 131. However, as shown in FIG. 3B, if the incident light strikes the light guide 120 farther away (for example, at a location 133) from the optical pattern generator 140 (for example, farther away from the edge mask), the pattern of the signal 200 also changes, for example, the frequency of the peaks increases.

In some arrangements, as shown and discussed with respect to FIGS. 2A-3B, the optical pattern generator 140 can be an edge mask with an array of apertures. The edge mask, in some implementations, may block part of the transmitted light so the signal strength may become weaker. For example, a 50% duty cycle edge mask can cut the light transmission by half. In some implementations, the light sensor 110 may also have a limited length smaller than the length of the edge of the light guide 120, while that same sensor is tasked with collecting light outputted across the whole length of the edge. For example, some light sensors 110 may cover about 50% to about 70% of the length of the long edge on a light guide (such as used with a 5.3 inch diagonal device). Thus, some sensors 110 may provide a lower resolution for information recovery for light from the corners of the light guide 120 than at the light from more central portions of the light guide 120. FIG. 4 illustrates a top-down view of an example of the light guide 120 and optical pattern generator 140 providing zones with different resolutions in conjunction with a light sensor 110 having a length less than the light output surface of the light guide 120 on which the light sensor 110 is disposed. The low resolution zones 139 can sometimes generate false pixel information. Thus, certain implementations of imaging systems 100 can include multiple sensors 110 or longer length sensors 110 that extend substantially the entire length of the matching output surface of the light guide 120.

FIGS. 5 and 6 illustrate top-down views of examples of an optical pattern generator 140 formed of an array of lenses disposed between the light output surface 123 of a light guide 120 and a light sensor 110. In certain implementations, a transparent microlens array or a cylindrical lens array can allow up to about 100% transmission of light towards the light sensor 110. For example, in some implementations, the lens array can allow about 75% or more, about 85% or more, about 90% or more, about 95% or more, about 98% or more, or about 99% or more transmission of light towards the light sensor 110. When compared to certain implementations utilizing an edge mask, certain implementations utilizing a lens array can allow a higher signal to noise ratio and greater resolution of information regarding light striking the light guide 120. Furthermore, sensors in certain implementations utilizing a lens array can have a wider field of view compared to sensors in certain implementations utilizing an edge mask, which generally functions as a one dimensional pin hole camera with a small field of view. Thus, with a lens array in some implementations, the light sensor 110 can detect more light from the ends of the edges of the light guide 120 and the low resolution zone can be reduced. Both FIGS. 5 and 6 show examples of implementations with a cylindrical microlens array disposed between the light output surface 123 of the light guide 120 and the light sensor 110 facing the light output surface 123 of the light guide 120. In some implementations, as shown in FIG. 5, the lens array can include an array of curved surfaces facing the light sensor 110, while in other implementations, as shown in FIG. 6, the lens array can include an array of curved surfaces facing the light output surface 123 of the light guide 120. In some implementations, the lens array in FIG. 5 can be integrated with the light guide 120. In some implementations, the lens array in FIG. 6 can be integrated with the light sensor 110.

As shown in FIG. 1A, the light sensor 110 can be provided near the light guide 120, for example, facing the light output surface 123 of the light guide 120. The light sensor 110 can include, for example, a photodetector array. In some implementations, the light sensor 110 can include one or more of an image sensor (such as a CMOS sensor, or a CCD sensor, including linear CCD or CMOS arrays), single or multiple photodiodes, and a micro-camera. The light sensor 110 can include portions s₁, s₂, s₃, . . . sₙ (see FIG. 1A) that are configured to receive the directed ambient light outputted from the light guide 120. For example, the light sensor 110 can receive the directed ambient light from the light guide 120 as the light intensity pattern projected by the optical pattern generator 140. The portions s₁, s₂, s₃, . . . sₙ, of the light sensor 110 can be capable of sensing the light including wavelengths outside of the visible spectrum. In some implementations, a light source (not illustrated) for emitting light of those wavelengths can be provided as part of the imaging system. Suitable wavelengths include ultraviolet (UV), infrared (IR), as well as wavelengths within the visible range. For example, in some implementations, the light sensor 110 can be used in an optical touch system. In some such implementations, the light sensor 110 can be capable of sensing light at IR wavelengths to detect a touch event, which may be caused by IR light reflecting off an object, such as a finger, over the light guide 120. The IR light being reflected can, in some implementations, be emitted by a light source emitting IR light, which may be part of the optical touch system.

As discussed above, the light turning features 130 can direct at least a portion of the ambient light out though an output surface 123 of the light guide 120 and to overlapping portions of the light sensor 110. For example, one light turning feature may direct light to portions s₁, s₂, s₃, . . . s₁₀ of the light sensor 110 (see FIG. 1A), while another light turning feature may direct light to portions s₂, s₃, . . . s₁, of the light sensor 110. In various implementations, the light turning features 130 may direct light to substantially all portions s₁, s₂, s₃, . . . sₙ of the light sensor 110, although light striking different portions may have different intensities.

Although FIGS. 1A-6 illustrate a light sensor 110 disposed facing one edge of a light output surface 123 of the light guide 120, the light sensor 110 can be disposed facing two, three, or more edges of the light guide 120. Thus, the imaging system 100 can include one or more additional light sensors 110 disposed facing one or more other edges (e.g., one or more of edges 124-126) of the light guide 120. For example, the light sensor 110 can be disposed facing two neighboring edges to retrieve a two dimensional light distribution. To increase resolution, detection on multiple edges, such as four edges (for example, edges 123-126), can be used. In such implementations, each light sensor 110 may receive information from half of the surfaces along one axis, in cases where the light guide 120 has a rectangular shape. In certain such implementations, the optical pattern generator 140 can be configured to project the light intensity pattern onto overlapping portions of individual additional light sensors 110. Various implementations of imaging systems 100 can also utilize additional optical pattern generators 140.

FIG. 7 illustrates a perspective view of an example of an imaging system 100 including multiple light sensors 113-116 disposed facing multiple light output surfaces of the light guide 120. Each edge 123-126 of the light guide 120 can form a light output surface. In addition, the example imaging system 100 can include multiple optical pattern generators 143-146 disposed between the light output surfaces 123-126 of the light guide 120 and the light sensors 113-116. Each of the optical pattern generators 143-146 is shown as an opaque edge mask with transparent apertures for each of illustration. However, in some implementations, one or more of the optical pattern generators 143-146 can be an array of lenses as shown in FIGS. 5 and 6.

The imaging system 100 can include a processor 150 as shown in FIG. 1A in communication with the light sensor(s) 113-116. The processor 150 can include a microcontroller, CPU, or logic unit to allow construction of images by the imaging system. The processor 150 can be configured to construct an image based on the light intensity pattern. For example, ambient light incident on different portions p₁, p₂, p₃, . . . pₘ of a surface, for example, a major surface such as the front surface 121, of the light guide 120 can cause different light intensity patterns, as discussed herein. The processor 150 can be configured to access a database that includes reference characterizations of light intensity patterns. Each reference characterization can be empirically determined based upon the light intensity patterns previously found to be associated with light incident on a different portion, e.g., p₁, p₂, p₃, . . . pₘ, of the light receiving surface. In addition, the processor 150 can determine which portions, e.g., p₁, p₂, p₃, . . . or pₘ, of the light receiving surface received ambient light based upon a comparison of the observed light intensity patterns and the reference characterizations.

FIG. 8 illustrates a top-down view of an example of an imaging system 100 with a light receiving surface divided into multiple portions p₁, p₂, p₃, and p₄, and a light sensor 110 divided into multiple portions s₁, s₂, s₃, . . . s₃₂. In some implementations, each of the four light receiving portions p₁, p₂, p₃, and p₄ of the light receiving surface can be considered a light receiving “pixel”. In some implementations, the “pixels” may correlate with one or more particular light turning features 130. However, in some other implementations, the pixels may just conveniently divide the light receiving surface into particular portions without correlating to a particular physical feature. The 32 portions s₁, s₂, s₃, . . . s₃₂ of the light sensor(s) can correspond to 32 light sensing portions facing at least one of the light output surfaces 123-126 of the light guide 120. The processor 150 can be configured to correlate the light intensity pattern with the different light receiving portions p₁, p₂, p₃, and p₄ of the light receiving surface of the light guide 120 to determine a pixelated image using the reference characterizations.

For example, when light strikes the light guide 120 and is turned by a light turning feature 130, the light turning feature 130 can effectively be considered a discrete light source. Thus, the plurality of light turning features 130 can effectively be considered an extended source of light on the light guide surface, which can be described by the spatial distribution U(x,y). Dividing the light receiving surface into a rectangular grid of discretized light sources (for example, corresponding to the light receiving portions p₁, p₂, p₃, . . . pₘ) can give the distribution Uᵢ(x,y) where i can represent the ith portion p₁. The number i can vary from 1 to the total number of light receiving portions m. If the light receiving surface is broken into an M by N rectangular grid of portions, then the total number of portions m can be equal to the product MN. The portions can be described in terms of an (m,1) column vector U, where each vector element i can be proportional to the light flux received and turned in the light guide 120 at the ith position (for example, portion pᵢ). The light flux (which can be proportional to Uᵢ) can propagate in the light guide 120 out through its periphery, pass through the optical pattern generator 140, and be detected by the light sensor 110. For example, the light flux can be collected by the kth sensing portion sₖ, where k can be a number from 1 to the total number of sensing portions n. The sensor signal can be represented as an (n,1) column vector S. The efficiency by which light from the ith portion p₁ propagates to the kth sensing portion sₖ can be given by G_{k,i}. The efficiencies can populate an (n, m) matrix G. In some implementations, the matrix G may refer to a propagation matrix which can map the propagation of light from each portion pᵢ on the light receiving surface to each light sensing portion sₖ. The formation of a signal S from the light receiving surface U may be described by the following matrix equation:

S=GU (1)

where S can relate to the light intensity pattern received by the light sensor 110, G can relate to the reference characterizations, and U can relate to the pixelated image to be constructed.

To determine the reference characterization, when each light receiving portion p₁, p₂, p₃, and p₄ of the light receiving surface is individually illuminated, for example, with a light source, each light sensing portion s₁, s₂, s₃, . . . s₃₂ of the light sensor 110 can receive light according to its position (for example, distance) relative to the illuminated portions p₁, p₂, p₃, and p₄ of the light receiving surface. For example, when only light receiving portion p₁ is illuminated, light sensing portions s₁, s₂, s₃, s₄, s₂₉, s₃₀, s₃₁, and s₃₂ of the light sensor 110 closest to the light receiving portion p₁ can receive the greatest amounts of light compared to the other light sensing portions. Likewise, light sensing portions s₁₆ and s₁₇ farthest from light receiving portion p₁ can receive the lowest amounts of light compared to the other light sensing pixels.

FIGS. 9A-9D illustrate examples of reference characterizations associated with light incident on the different portions p₁, p₂, p₃, and p₄ of the light receiving surface shown in FIG. 8. The normalized values of the amount of light that can be received by each light sensing portion s₁, s₂, s₃, . . . s₃₂ when light strikes the light receiving portion p₁ can be placed in a first column vector of G. The actual numerical values in the first column vector of G can be replaced by grey scale shading as a visual illustration guide with lighter shades representing larger values as shown in FIG. 9A to form a reference characterization for light receiving portion p₁. The above illustration can be used to similarly determine the reference characterization of the normalized values of the amount of light that is received by each light sensing portion s₁, s₂, s₃, . . . s₃₂ from each of the light receiving portions p₂, p₃, and p₄. These values can be placed as the second, third, and fourth column vectors of G or as visually illustrated in FIGS. 9B, 9C, and 9D to form the reference characterizations for light receiving portions p₂, p₃, and p₄ respectively. The reference characterizations can be stored in a database, for example, a look-up table (LUT), that is accessible by the processor 150 of the imaging system 100. The database can be stored on a computer-readable medium such as those described herein.

Certain implementations can construct an image electronically, such as by software, using the light intensity pattern collected by the light sensor 110 and the reference characterizations discussed above, without first forming or projecting the image on the light sensor 110 (that is, without, for example, focusing an image onto the light sensor 110 using lenses). As an example, an algorithm to determine the pixelated image from the light intensity pattern and the reference characterizations can include solving for U with the following relationship:

U=G⁻¹S (2)

where G⁻¹ can be a pseudo-inverse matrix relating the reference characterizations. The pseudo-inverse can provide one method to achieve image construction. It can be equivalent to a least-squared optimization with a non-negativity constraint. Other solutions and algorithms are possible.

FIG. 10 illustrates a top-down schematic view of an experimental imaging system. The surface of the light guide 120 (130 mm×100 mm×0.5 mm) was divided into a 20×15 pixel array having 300 light receiving portions p₁, p₂, p₃, . . . p₃₀₀. The light guide 120 was made of glass with light turning facets positioned on the back surface (the surface on the opposite side of the light guide 120 relative to the user or scene to be captured). The peripheral optical pattern generator 140 included four edge masks including transparent apertures in an otherwise opaque mask. The pitch of each mask was 1.27 mm. The light sensor 110 included four 63.5 micron×63.5 micron linear photodetector arrays positioned adjacent each edge mask with a 4 mm air gap. Each light sensor was divided into 1280 light sensing portions for a total of 5120 light sensing portions s₁, s₂, s₃, . . . s₅₁₂₀. A liquid crystal (LC) modulator was positioned adjacent the light guide 120 with a separation of about 10 mm. FIG. 11 illustrates a visual representation of examples of the reference characterizations determined for the experimental case shown in FIG. 10. With 300 light receiving portions p₁, p₂, p₃, . . . p₃₀₀ and 5120 light sensing portions s₁, s₂, s₃, . . . or s₅₁₂₀, G contained a 5120×300 matrix, for example, 5120 rows and 300 columns. The rows are segregated into four sections with each section containing 1280 rows corresponding to the number of sensing portions on each side of the light guide 120. Each section then corresponds to the signal measured on one side of the imaging system. Each column corresponds to signals collected in all 5120 sensing portions s₁, s₂, s₃, . . . s₅₁₂₀, when only one light receiving portion p₁ is providing light to the light sensor. For example, the left most column represents the light flux propagating from the light receiving portion p₁ to all 5120 sensing portions s₁, s₂, s₃, . . . s₅₁₂₀. The second column represents the light flux propagating to all 5120 sensing portions s₁, s₂, s₃, . . . s₅₁₂₀ when only light receiving portion p₂ is providing light to the light sensor.

FIGS. 12A-12B illustrate the original scenes captured by the experimental imaging system shown in FIGS. 10 and 11. In this example, the scene to be captured included a display showing the letters A and Q, with the display placed about 1 cm above the surface of the light guide 120. Light emitted from the letters was received by the light receiving portions p₁, p₂, p₃, . . . and/or p₃₀₀ and directed towards to the light output surfaces of the light guide 120. The optical pattern generator(s) 140 generated a light intensity pattern upon passage of the directed light from the light output surfaces through the optical pattern generator(s) 140. The optical pattern generator(s) 140 projected the light intensity pattern onto the light sensing portions s₁, s₂, s₃, . . . s₅₁₂₀ of the light sensor(s) 110. An image was constructed using the light intensity pattern and the earlier-determined reference characterizations to determine which portions p₁, p₂, p₃, . . . and/or p₃₀₀ of the light guide 120 had received light. FIGS. 12C-12D illustrate the results of the letters constructed using the example case shown in FIGS. 10 and 11. The images are recognizable as the letters A and Q. In certain implementations, linear and/or nonlinear post filtering options can be applied to refine the constructed image.

FIG. 13A illustrates an example method 500 of constructing an image. The method 500 can be performed by various implementations of the imaging system 100 described herein. For example, the method 500 can include receiving ambient light through a major surface of a light guide as shown in block 510, and directing the ambient light out through an output surface of the light guide, as shown in block 520. The received light may be turned towards the output surface by light turning features in the light guide. As shown in block 530, the method 500 can also include generating a light intensity pattern. For example, the light intensity pattern can be generated by an optical pattern generator upon the passage of the ambient light through the optical pattern generator. As shown in block 540, the method 500 can further include projecting the light intensity pattern onto portions of a light sensor. In some implementations, the method can include projecting the light intensity pattern onto overlapping portions of a light sensor. Furthermore, the method 500 can include constructing the image based on the light intensity pattern as shown in block 550. For example, the image can be constructed by a processor (FIG. 1A) in communication with the light sensor.

In some implementations, directing the ambient light can include turning, by the light turning features, the ambient light incident upon the major surface surface of the light guide from substantially all angular directions. Furthermore, in some other implementations, directing the ambient light can include turning, by the light turning features 130, the ambient light received within a particular range of angular directions (such as, within a particular cone of acceptance angles). In some implementations, some of the light turning features 130 can turn the ambient light received from substantially the same range of angular directions. In other implementations, some of the light turning features 130 can turn the ambient light received from different ranges of angular directions. At least some of the ranges can partially overlap. Furthermore, directing the ambient light can include, in some implementations, directing the light received by the light turning features 130 from the ranges of angular directions out through the output surface 123 of the light guide 120 and through an optical pattern generator 140. In some implementations, the optical pattern generator 140 can include an array of apertures and/or an array of lenses.

In some implementations of the method 500, constructing the image as shown in block 550 can include receiving the light intensity pattern corresponding to light distributions caused by the ambient light incident on different portions of a major surface of the light guide 120. Constructing the image can also include accessing a database that includes reference characterizations of light intensity patterns. Each reference characterization can be associated with light incident on a different portion of the major surface. Constructing the image can further include determining which portions of the major surface received ambient light based upon the light intensity patterns and the reference characterizations.

Some implementations of the imaging system 100 described herein (for example, as shown in FIG. 1A) may optionally include a display including a plurality of display elements (not illustrated) underlying the light guide 120. In some implementations, the display can be a reflective display. In some implementations, the display can be an electromechanical systems display or a reflective electromechanical systems display. In some implementations, the display can be an interferometric modulator reflective display provided with interferometric modulator display elements. In implementations with a reflective display underlying the light guide 120, the light guide 120 may form part of a front light for illuminating the reflective display. In such an implementation, the imaging system 100 may further include a light source (not illustrated) in optical communication with the light guide 120 or front light, and a second plurality of light turning features (for example, features in a hologram and/or reflective, faceted features) may be provided to direct light from the light source to the display for display illumination.

FIG. 13B illustrates an example of instructions implemented on a computer-readable medium used to direct a processor to construct an image. For example, the methods to construct an image described herein can be implemented in software, for example, in a processor-executable software module which resides on a computer-readable medium. The processor can be a processor as described herein, for example processor 150 shown in FIG. 1A and/or the processor 21 shown in FIGS. 15 and 16B. As shown in FIG. 13B, the instructions 600 can direct the processor to construct an image by receiving signals indicative of a light intensity pattern from a light sensor as shown in block 610. The light intensity pattern can correspond to light distributions caused by ambient light incident on different portions of a major surface of a light guide. The instructions 600 can also direct the processor to access a database that includes reference characterizations of different light intensity patterns as shown in block 620. Each reference characterization can be associated with light incident on a different portion of the major surface. As shown in blocks 630 and 640, the processor can be instructed to determine which portions of the major surface received ambient light based upon the light intensity pattern and the reference characterizations; and to construct the image based on the determined portions. As described herein, one method to determine which portions of the major surface received ambient light based upon the light intensity pattern and the reference characterizations can include using a pseudo-inverse matrix relating to the reference characterizations. See, for example, Equation (2). In some implementations, the light intensity pattern can include a superimposition of light intensity patterns for the different portions of the major surface of the light guide that received the ambient light.

As described herein, certain implementations of imaging systems 100 and methods 500 can be utilized in display devices including interferometric modulator (IMOD) display elements. FIG. 14 is an isometric view illustration depicting two adjacent interferometric modulator display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 14 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage Vₒ applied across the display element 12 on the left is insufficient to cause actuation of the movable reflective layer 14 to an actuated position such as that of the display element 12 on the right.

In FIG. 14, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 14 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (for example, of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 14, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 14. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 15 is a system block diagram illustrating an electronic device incorporating an IMOD-based display including a three element by three element array of IMOD display elements. The electronic device includes a processor 21 that may be configured to execute one or more software modules, including imaging modules. In addition to executing an operating system, the processor 21 may be configured to execute one or more software applications, including a web browser, a telephone application, an email program, or any other software application. In some implementations, the processor 21 can be the processor 150 shown in FIG. 1A and described herein.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 14 is shown by the lines 1-1 in FIG. 15. Although FIG. 15 illustrates a 3×3 array of IMOD display elements for the sake of clarity, the display array 30 may contain a very large number of IMOD display elements, and may have a different number of IMOD display elements in rows than in columns, and vice versa.

FIGS. 16A and 16B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 16A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 (or such as the processor 150) and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 16A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), IxEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Although not explicitly illustrated, one or more light sensors 113, 114, 115, and 116 (see FIG. 7) can also be configured as input devices for capturing images, or indicating touch events, as described elsewhere herein. As noted above, the processor 21 (or processor 150, see FIG. 1A) and the input device 48 also may serve as an image source module, and hence the processor can generate images using input or data from one or more light sensors along with reference characterizations stored in memory.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. For example, as shown in FIG. 13B, the steps of a method to direct a processor to construct an image can be implemented in a non-transitory tangible computer storage medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An imaging system, comprising:
a light sensor;
a light guide including a plurality of light turning features, at least some of the light turning features configured to receive ambient light and to direct the ambient light out through an output surface of the light guide to the light sensor;
an optical pattern generator disposed between the output surface and the light sensor, the optical pattern generator configured to:
generate a light intensity pattern upon the passage of the ambient light through the optical pattern generator; and
project the light intensity pattern onto the light sensor; and
a processor in communication with the light sensor, the processor configured to construct an image based on the light intensity pattern.

2. The imaging system of claim 1, wherein ambient light incident on different portions of a major surface of the light guide cause different light intensity patterns, wherein the processor is configured to:
access a database that includes reference characterizations of light intensity patterns, each reference characterization associated with light incident on a different portion of the major surface; and
determine which portions of the major surface received ambient light based upon the light intensity patterns and the reference characterizations.

3. The imaging system of claim 1, wherein the light turning features are configured to receive the ambient light from substantially the same range of angular directions.

4. The imaging system of claim 1, wherein each light turning feature is configured to turn the ambient light received from a range of angular directions, wherein the ranges for at least some of the light turning features at least partially overlap.

5. The imaging system of claim 1, wherein the at least some of the light turning features are configured to turn the ambient light received from a cone having an acceptance angle range of about 60 degrees to about 90 degrees, relative to a central axis of the cone.

6. The imaging system of claim 1, wherein the light turning features include light turning facets.

7. The imaging system of claim 6, wherein each of the light turning facets includes sides of a truncated cone.

8. The imaging system of claim 1, wherein the light sensor is disposed facing an edge of the light guide.

9. The imaging system of claim 8, further comprising one or more additional light sensors disposed facing one or more other edges of the light guide, wherein the optical pattern generator is configured to project the light intensity pattern onto the one or more additional light sensors.

10. The imaging system of claim 1, wherein the optical pattern generator includes an array of apertures.

11. The imaging system of claim 1, wherein the optical pattern generator includes an array of lenses.

12. The imaging system of claim 11, wherein the array of lenses includes an array of curved surfaces facing the light sensor.

13. The imaging system of claim 11, wherein the array of lenses includes an array of curved surfaces facing the light-output surface of the light guide.

14. The imaging system of claim 1, further comprising:
a display device underlying the light guide.

15. The imaging system of claim 14, wherein the display device is a reflective display.

16. The imaging system of claim 15, wherein the reflective display includes a plurality of interferometric modulator display elements.

17. The imaging system of claim 1, further comprising:
a display underlying the light guide, wherein the processor is configured to communicate with the display, the processor being configured to process image data; and
a memory device that is configured to communicate with the processor.

18. The imaging system of claim 17, further comprising:
a driver circuit configured to send at least one signal to the display; and
a controller configured to send at least a portion of the image data to the driver circuit.

19. The imaging system of claim 17, further comprising:
an image source module configured to send the image data to the processor, wherein the image source module includes at least one of a receiver, transceiver, and transmitter.

20. The imaging system of claim 17, further comprising:
an input device configured to receive input data and to communicate the input data to the processor.

21. An imaging system, comprising:
a light sensor;
a light guide including a plurality of light turning means, at least some of the light turning means configured to receive ambient light and to direct the ambient light out through an output surface of the light guide to the light sensor;
an optical pattern generating means disposed between the output surface and the light sensor, the optical pattern generating means configured to:
generate a light intensity pattern upon the passage of the ambient light through the optical pattern generating means; and
project the light intensity pattern onto the light sensor; and
means for processing in communication with the light sensor, the processing means configured to construct an image based on the light intensity pattern.

22. The imaging system of claim 21, wherein the light turning means includes light turning facets, optical pattern generating means includes at least one of an array of apertures and an array of lenses, or the processing means includes a processor.

23. The imaging system of claim 21, wherein ambient light incident on different portions of a major surface of the light guide cause different light intensity patterns, wherein the processing means is configured to:
access a database that includes reference characterizations of light intensity patterns, each reference characterization associated with light incident on a different portion of the major surface; and
determine which portions of the major surface received ambient light based upon the light intensity patterns and the reference characterizations.

24. The imaging system of claim 21, wherein the light turning means are configured to receive the ambient light from substantially the same range of angular directions.

25. The imaging system of claim 22,
wherein the array of apertures includes an opaque edge mask with apertures or
wherein the array of lenses includes at least one of an array of curved surfaces facing the light sensor and an array of curved surfaces facing the light-output surface of the light guide.

26. A non-transitory tangible computer storage medium having stored thereon instructions to direct a processor to construct an image by:
receiving signals indicative of a light intensity pattern from a light sensor, the light intensity pattern corresponding to light distributions caused by ambient light incident on different portions of a major surface of a light guide;
accessing a database that includes reference characterizations of different light intensity patterns, each reference characterization associated with light incident on a different portion of the major surface;
determining which portions of the major surface received ambient light based upon the light intensity pattern and the reference characterizations; and
constructing the image based on the determined portions.

27. The method of claim 26, wherein determining which portions of the major surface received ambient light includes using a pseudo-inverse matrix relating to the reference characterizations.

28. The method of claim 26, wherein the light intensity pattern includes a superimposition of light intensity patterns for the different portions of the major surface of the light guide that received the ambient light.
